(19) United States
(12) Patent Application Publication
(10) Pub. No.: US 2005/0172937 A1
(43) Pub. Date: Aug. 11, 2005

(54) Device for supplying fuel to internal combustion engine

(75) Inventors: Mikio Torii, Hekinan-city (JP); Takashi Koba, Nishikamo-gun (JP); Tetsuro Okazono, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/047,704

(22) Filed: Feb. 2, 2005

(30) Foreign Application Priority Data
Feb. 5, 2004 (JP) 2004-29236

(51) Int. Cl. F02M 37/04

(52) U.S. Cl. 123/509

(57) ABSTRACT

A fuel supply device is composed of a bottom cover closing a bottom opening of a fuel tank and a fuel pump module mounted on the bottom cover. The fuel pump module includes a fuel pump for sucking fuel contained in the fuel tank, a pressure regulator for regulating fuel pressure by discharging part of the fuel sucked by the fuel pump and a fuel level detector for detecting a fuel level in the fuel tank. The fuel pump module is submerged in fuel contained in the fuel tank. The fuel level detector is positioned apart from the pressure regulator in both the horizontal and vertical directions, so that the fuel level detector accurately detects the fuel level without being disturbed by a fuel flow discharged from the pressure regulator.

### CROSS-REFERENCE TO RELATED APPLICATION

This application is based upon and claims benefit of priority of Japanese Patent Application No. 2004-29236 filed on Feb. 5, 2004, the content of which is incorporated herein by reference.

### BACKGROUND OF THE INVENTION

1. Field of the Invention

The present invention relates to a device for supplying fuel to an internal combustion engine, the device being submerged in a fuel tank.

2. Description of Related Art

An example of a fuel supply device which is submerged in a fuel tank is disclosed in JP-A-11-93794. This fuel supply device is constituted as a module including a fuel pump and a pressure regulator, and is used in a fuel tank of a motorcycle. The fuel supply device is installed in a fuel tank through an opening formed at a bottom plate of the fuel tank. It is required to make the bottom opening small so that the bottom opening is easily sealed. Accordingly, the fuel supply pump has to be made small in a horizontal direction. For this purpose, it is proposed to place a pressure regulator above a fuel pump and to place a fuel level detector below the fuel pump.

In this configuration, however, it is highly possible that fuel discharged from the pressure regulator flows downward due to gravity and hits the fuel level detector. If this occurs, the fuel level detector cannot correctly detect a fuel level in the fuel tank.

### SUMMARY OF THE INVENTION

The present invention has been made in view of the above-mentioned problem, and an object of the present invention is to provide an improved fuel supply device including a fuel level detector that is able to correctly detect a fuel level in a fuel tank.

The fuel supply device is installed in a fuel tank through a bottom opening formed in a bottom plate of the fuel tank and submerged in fuel contained in the fuel tank. The fuel supply device is composed of a bottom cover for closing the bottom opening of the fuel tank, a fuel pump supported on the bottom cover, a pressure regulator for regulating a pressure of fuel to be supplied to an internal combustion engine, and a fuel level detector for detecting a level of the fuel contained in the fuel tank.

The fuel contained in the fuel tank is sucked by the fuel pump through a suction port formed at a bottom portion of the fuel pump. The sucked fuel is pressurized in the fuel pump and sent to an outlet port through a cylindrical fuel filter disposed outside of the cylindrical fuel pump. Part of the pressurized fuel is sent to the pressure regulator that regulates a pressure of the fuel to be supplied to the internal combustion engine by discharging, or returning, the sucked fuel to the fuel tank. A level of the fuel contained in the fuel tank is detected by the fuel level detector mounted on the fuel pump.

The pressure regulator and the fuel level detector are disposed apart from each other in the fuel supply device, so that the fuel discharged from the pressure regulator does not directly hit the fuel level detector. In this manner, the fuel level detector accurately detects the fuel level in the fuel tank without being disturbed by the fuel flow discharged from the pressure regulator. The fuel level detector may be positioned above the pressure regulator, or vice versa, in the longitudinal direction of the fuel pump. With respect to the radial direction of the fuel pump, the pressure regulator is positioned opposite to the fuel level detector.

A cylindrical portion may be formed to stand upward from the bottom cover, and a cylindrical fuel filter may be disposed around the cylindrical fuel pump. The pressure regulator may be positioned between the fuel filter and the bottom cover. In this manner, the fuel supply device can be made compact to make the bottom opening of the fuel tank small. Further, a discharge port of the pressure regulator may be made to open to an inner space of the cylindrical portion, so that the fuel discharged from the pressure regulator stays at a bottom of the cylindrical portion. In this manner, the fuel can be sucked by the fuel pump up to the substantially last portion of the fuel in the fuel tank.

Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing a fuel supply device as a first embodiment of the present invention;

FIG. 2 is plan view showing the fuel supply device shown in FIG. 1, viewed from direction II shown in FIG. 1; and

FIG. 3 is a cross-sectional view showing a fuel supply device as a second embodiment of the present invention.

### DETAILED DESCRIPTION OF THE PREFERRED EMBODIMENTS

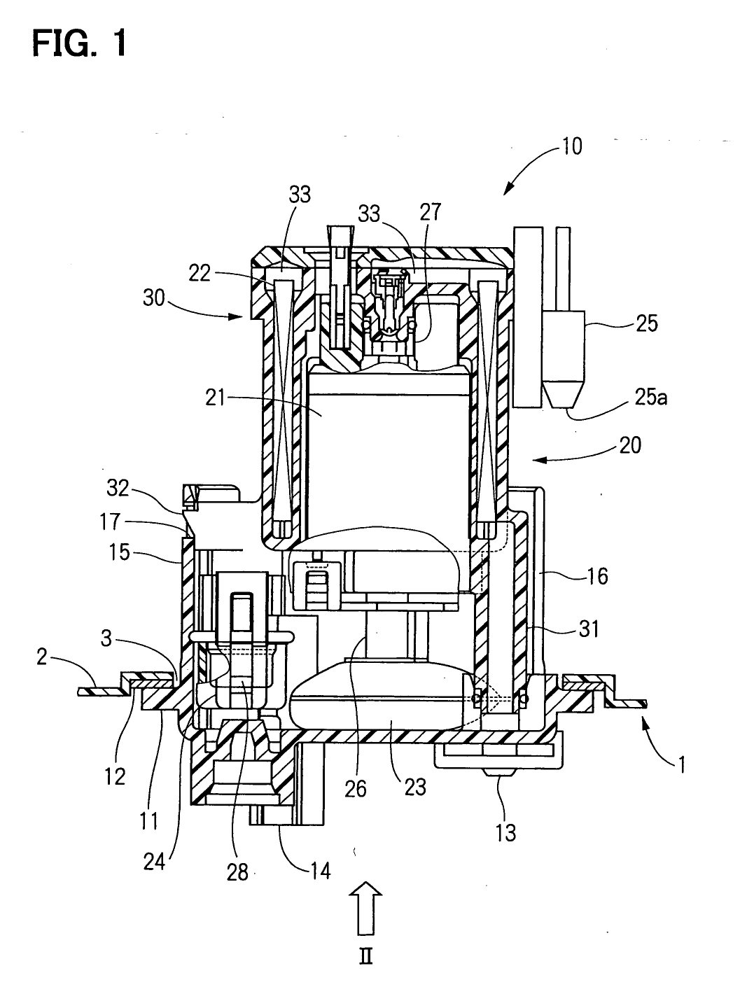

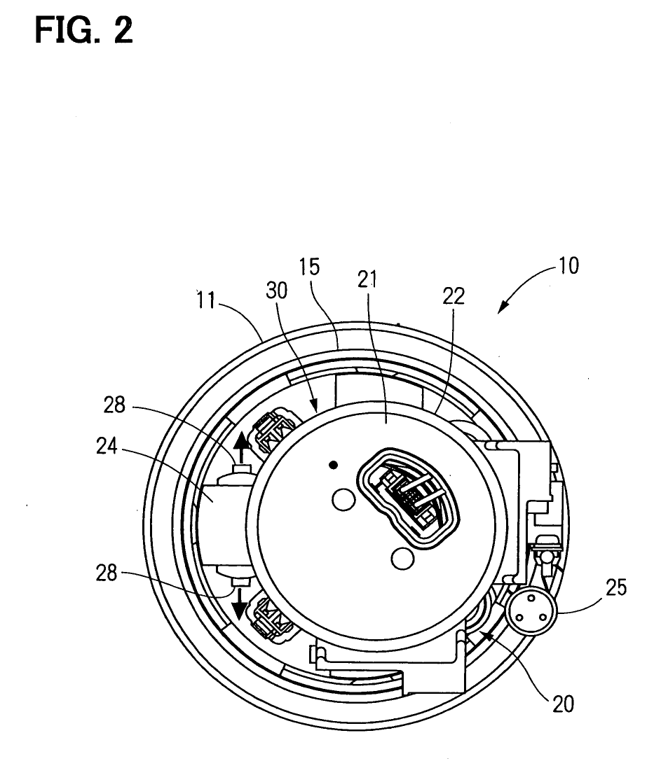

A first embodiment of the present invention will be described with reference to FIGS. 1 and 2. A device 10 for supplying fuel to an internal combustion engine (referred to as a fuel supply device 10) is used for a motorcycle. The fuel supply device 10 is submerged in a fuel tank 1 for pumping up fuel in the fuel tank and for supplying the fuel to the engine. This fuel supply device may be used for an automotive vehicle in a similar manner.

A bottom opening 3 is formed in a bottom plate 2 of the fuel tank 1. The fuel supply device 10 is composed of a bottom cover 11 for closing the bottom opening 3 of the fuel tank 1 and a fuel pump module 20 that is mounted on the bottom cover 11. The fuel pump module 20 is inserted into the fuel tank 1 through the bottom opening 3, and the bottom cover 11 closes the bottom opening 3. The bottom cover 11 is made of resin in a substantially round shape. The bottom cover 11 may be made of a metal such as a steel plate. The bottom opening 3 is liquid-tightly sealed with a gasket 12 disposed between the bottom plate 2 and the bottom cover 11. An outlet pipe 13, an electrical connector 14 and a cylindrical portion 15 are integrally formed with the bottom cover 11. These portions, however, may be separately formed and assembled to the bottom cover 11.

The cylindrical portion 15 is formed to extend upward from a round outer fringe of the bottom cover 11. The cylindrical portion 15 includes an inlet port 16 through which fuel in the fuel tank 1 flows into the cylindrical portion 15. The cylindrical portion 15 includes an upper opening, and a bottom part of the fuel pump module 20 is contained in the cylindrical portion 15.

The fuel pump module 20 includes a fuel pump 21, a fuel filter 22, a suction filter 23, a pressure regulator 24 and a fuel level detector 25. The fuel pump module 20 also includes a casing 30 in which the fuel pump 21, the fuel filter 22 and the pressure regulator 24 are contained. The casing 30 is made of resin and has an outlet passage 31 connected to the outlet pipe 13 of the bottom cover 11. A claw 32 sticking out from the casing 30 in the radial direction engages with an opening 17 of the cylindrical portion 15. Thus, the fuel pump module 20 is connected to the bottom cover 11.

The fuel pump 21 has a suction port 26 connected to the suction filter 23 and an outlet port 27. A cylindrical fuel filter 22 is disposed around the fuel pump 21. Fuel in the fuel tank 1 is sucked into the fuel pump 21 through the suction port 26 and the suction filter 23 that removes relatively large foreign particles contained in the fuel. The fuel sucked into the fuel pump 21 is pressurized therein, and the pressurized fuel is supplied to the engine through the outlet port 27, a fuel passage 33 formed in the casing 30, the filter 22, the outlet passage 31 and the outlet pipe 13, in this order. The filter 22 surrounding the fuel pump 21 removes relatively small particles contained in the fuel.

The pressure regulator 24 is disposed at a position close to the bottom of the bottom cover 11 and in a radial space between the filter 22 and the cylindrical portion 15 as better seen in FIG. 2. The pressure regulator 24 is connected to the fuel passage 33 positioned between the outlet port 27 and the filter 22. An excessive amount of fuel supplied from the fuel pump 21 is discharged through the pressure regulator 24, and thereby a pressure of the fuel flowing through the filter 22 is regulated. The excessive amount of fuel is discharged through a discharge port 28 of the pressure regulator 24. The discharged fuel flows substantially in parallel to the bottom plate of the bottom cover 11 along the inner periphery of the cylindrical portion 15, as shown by arrows in FIG. 2. Accordingly, the discharged fuel is retained in cylindrical portion 15 in the vicinity of the suction filter 23.

The fuel level detector 25 is positioned at an upper portion of the fuel pump module 20 and at an opposite side of the pressure regulator 24. In other words, the fuel level detector 25 is positioned opposite to the pressure regulator 24 with respect to the radial direction of the fuel pump 21, as better seen in FIG. 2. Therefore, the fuel flow discharged from the pressure regulator 24 does not hit the fuel level detector 25. The fuel level detector 25 is set so that electrical contacts therein close, when an amount of fuel in the fuel tank 1 decreases and the fuel level is lowered to the position of a bottom end 25a of the fuel level detector 25. Alternatively, the electrical contacts may be opened when the fuel level is lowered to the position of the bottom end 25a.

Advantages attained in the first embodiment described above will be summarized below. Since the fuel level detector 25 is positioned above the pressure regulator 24 in the vertical direction and apart from the pressure regulator 24 in the horizontal direction, the fuel flow discharged from the pressure regulator 24 does not hit the fuel level detector 25. Therefore, the fuel level detector 25 can accurately detect the fuel level without being disturbed by the fuel flow discharged from the pressure regulator 24.

Since the fuel discharged from the pressure regulator 24 is retained within the cylindrical portion 15 around the suction filter 23, the fuel pump 21 can suck the fuel retained around the suction filter 23 even when the fuel level in the fuel tank becomes very low. In other words, the fuel in the fuel tank can be sucked by the fuel pump 21 up to the substantially last portion.

Since the pressure regulator 24 is positioned in the space between the fuel filter 22 and the cylindrical portion 15 of the bottom cover 11, the pressure regulator 24 does not stick out from the bottom cover 11. Accordingly, the size of the fuel supply device 10 in the radial direction, or a horizontal direction, can be kept small. Therefore, it is not necessary to enlarge the size of the bottom opening 3, and the liquid-tight sealing of the bottom opening is easily attained.

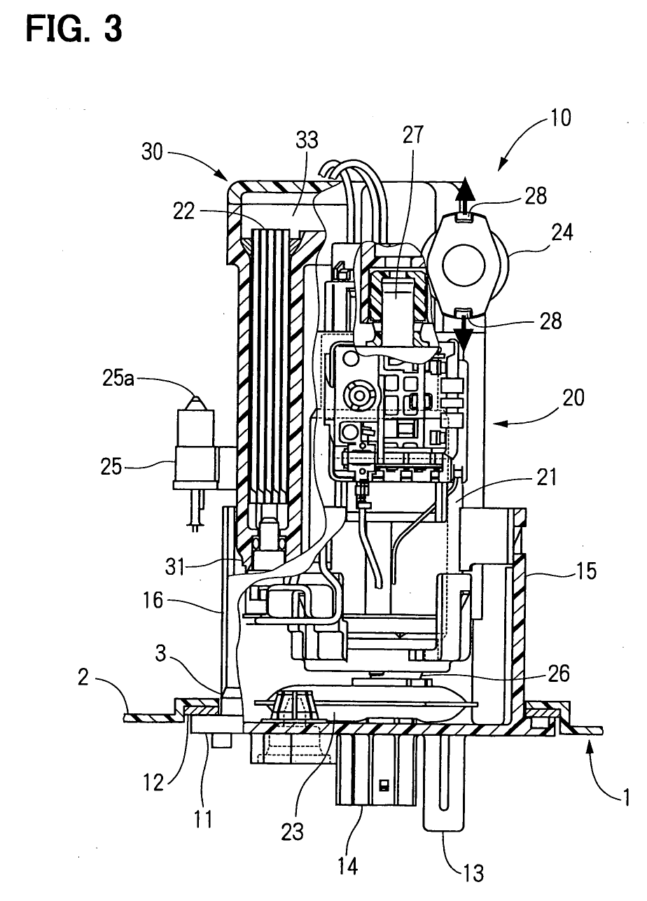

A second embodiment of the present invention is shown in FIG. 3. In this second embodiment, only the positions of the pressure regulator 24 and the fuel level detector 25 are different from those of the first embodiment. Other structures are the same as those of the first embodiment, and the same components as those of the first embodiment have the same reference numbers. In the second embodiment, the pressure regulator 24 is positioned at an upper portion of the fuel supply device 10, while the fuel level detector 25 is positioned at a middle portion of the fuel supply device 10. The fuel level detector 25 is connected to the casing 30 so that the bottom end 25a is directed upward. Further, with regard to the radial direction of the fuel pump module 20, the fuel level detector 25 is positioned opposite to the pressure regulator 24.

Since the fuel level detector 25 is positioned apart from the pressure regulator 24 as described above, the fuel flow discharged from the pressure regulator 24 (shown with arrows in FIG. 3) does not hit the fuel level detector 25. Therefore, the fuel level detector 25 accurately detects the fuel level in the fuel tank 1 without being disturbed by the fuel flow discharged from the pressure regulator 24.

Though the fuel supply device 10 for use in a motorcycle is described above, the fuel supply device 10 may be used in an automobile vehicle. While the present invention has been shown and described with reference to the foregoing preferred embodiments, it will be apparent to those skilled in the art that changes in form and detail may be made therein without departing from the scope of the invention as defined in the appended claims.

1. A device for supplying fuel to an internal combustion engine, the device being submerged in fuel contained in a fuel tank, the device comprising:
a bottom cover closing a bottom opening of a fuel tank;
a cylindrical fuel pump for sucking fuel in the fuel tank and for supplying fuel to the internal combustion engine, the fuel pump being disposed on the bottom cover to stand upward therefrom;
a pressure regulator for regulating a pressure of the fuel to be supplied to the internal combustion engine by discharging part of the fuel sucked by the fuel pump to the fuel tank; and
a fuel level detector for detecting a level of the fuel contained in the fuel tank, the fuel level detector being positioned at a position where a flow of the fuel discharged from the pressure regulator does not hit the fuel level detector.

2. A device for supplying fuel to an internal combustion engine, the device being submerged in fuel contained in a fuel tank, the device comprising:
a bottom cover closing a bottom opening of a fuel tank;
a cylindrical fuel pump for sucking fuel in the fuel tank and for supplying fuel to the internal combustion engine, the fuel pump being disposed on the bottom cover to stand upward therefrom;
a pressure regulator for regulating a pressure of the fuel to be supplied to the internal combustion engine by discharging part of the fuel sucked by the fuel pump to the fuel tank; and
a fuel level detector for detecting a level of the fuel contained in the fuel tank, the fuel level detector being positioned opposite to the pressure regulator with respect to the radial direction of the cylindrical fuel pump.

3. A device for supplying fuel to an internal combustion engine, the device being submerged in fuel contained in a fuel tank, the device comprising:
a bottom cover closing a bottom opening of a fuel tank;
a cylindrical fuel pump for sucking fuel in the fuel tank and for supplying fuel to the internal combustion engine, the fuel pump being disposed on the bottom cover to stand upward therefrom;
a pressure regulator for regulating a pressure of the fuel to be supplied to the internal combustion engine by discharging part of the fuel sucked by the fuel pump to the fuel tank; and
a fuel level detector for detecting a level of the fuel contained in the fuel tank, the fuel level detector being positioned upward of the pressure regulator with respect to the axial direction of the cylindrical fuel pump.

4. The device as in claim 1, wherein:
the pressure regulator is positioned in the vicinity of the bottom cover, and the fuel level detector is positioned in the vicinity of an upper end of the cylindrical fuel pump.

5. The device as in claim 1, wherein:
the pressure regulator is positioned opposite to the fuel level detector in the radial direction of the cylindrical fuel pump.

6. The device as in claim 1, wherein:
the device further comprises a fuel filter for filtering the fuel to be supplied to the internal combustion engine, the fuel filter being disposed at a radial outside of the cylindrical fuel pump; and
the pressure regulator is positioned between the fuel filter and the bottom cover.

7. The device as in claim 1, wherein:
the bottom cover is formed in a substantially round shape, and the bottom cover includes a cylindrical portion standing upward from the bottom cover.

8. The device as in claim 7, wherein:
the pressure regulator is disposed inside the cylindrical portion of bottom cover.

9. The device as in claim 8, wherein:
the pressure regulator includes a discharge port for discharging part of the fuel sucked by the fuel pump, the discharge port being open to an inside of the cylindrical portion of the bottom cover.
